(19) United States
(12) Patent Application Publication
(10) Pub. No.: US 2026/0301733 A1
(43) Pub. Date: Oct. 1, 2026

(54) SYSTEMS AND METHODS FOR GENERATING CONTEXT-ORIENTED SUMMARY OF AUDIO CONVERSATIONS IN REAL TIME

(71) Applicant: GENESYS CLOUD SERVICES, INC., MENLO PARK, CA (US)

(72) Inventors: NIRANJAN AKELLA, HYDERABAD (IN); NARESHKUMAR ELLURU, HYDERABAD (IN); PAVAN BUDUGUPPA, HYDERABAD (IN); RAMASUBRAMANIAN SUNDARAM, HYDERABAD (IN)

(73) Assignee: GENESYS CLOUD SERVICES, INC., MENLO PARK, CA (US)

(21) Appl. No.: 19/094,213

(22) Filed: Mar. 28, 2025

(51) Int. Cl. G10L 15/16; G10L 15/183; G10L 25/18

(52) U.S. Cl. CPC G10L 15/16; G10L 15/183; G10L 25/18

(57) ABSTRACT

A system for generating context-oriented summaries of audio conversations in real time includes a principal model with a transformer-based model and a natural language processing model and is pre-trained with training audio data to generate summaries. The pre-trained principal model receives real-time audio data, which is processed by the transformer-based model to generate a series of encoder hidden state tensors. The series of encoder hidden state tensors is processed by an independent self-attention layer to generate a new set of hidden states, which are processed by a mean pooling module to generate a single fixed-length tensor representation, which is processed by the decoder to generate context-oriented summaries of the real-time audio data.

### FIELD OF THE INVENTION

The present invention generally relates to customer relations services and customer relations management via contact centers and associated cloud-based systems. More particularly, but not by way of limitation, the present invention pertains to systems and methods for generating context-oriented summary of audio conversations in real time.

### BACKGROUND

Contact center agents often need to summarize customer calls for various purposes, such as assisting other agents in future interactions or for analytical insights. However, manually creating these summaries is time-consuming and may result in incomplete, inaccurate, or inconsistent information. Alternative methods for generating summaries require agents to review lengthy transcripts of call recordings and use the transcribed text to create summaries. While some AI techniques for text summarization use transcriptions, they are often ineffective due to the unstructured nature of human conversations and errors in speech recognition. As a result, traditional natural language processing (NLP) text summarization methods do not work well for summarizing contact center calls. Similarly, conventional audio signal processing techniques, although useful for tasks like speech recognition or environmental sound classification, often fail to account for the sequential dependencies present in the audio, limiting their ability to accurately summarize dynamic human conversations.

### BRIEF DESCRIPTION OF THE INVENTION

Techniques are provided for generating context-oriented audio summary from conversations.

In an example embodiment, a system for generating context-oriented summary of audio conversations in real time, comprises a principal model which is pre-trained with training audio data to generate summary and the principal model includes a transformer-based model and a hybrid summary generation module, wherein the transformer-based model comprises a spectrogram generation module, a One Dimensional Convolutional Neural Network (1D CNN) layer, a sinusoidal positional embedding module, an encoder and a decoder. The principal model after pretraining receives real-time audio data which is processed by the transformer-based model to generate a series of encoder hidden state tensors at the output of the encoder of the transformer-based model, wherein the encoder includes convolutional neural networks (CNN) layers followed by self-attention layers. The system further includes an independent self-attention layer to transform the series of encoder hidden state tensors into a new set of hidden states based on additional weighted attention scores of the independent self-attention layer, a mean pooling module, to transform the new set of hidden states into a single fixed-length tensor representation. The system further includes the decoder, which uses the additional weighted attention scores of the independent self-attention layer to select relevant features from the single fixed-length tensor representation and generate context-oriented summaries of the real time audio data.

In an example embodiment, the mean pooling module of the system transforms the encoder hidden state tensors into a single fixed-length tensor representation and the decoder of the system utilizes weighted attention scores of encoder's self-attention layers to select the relevant features from the single fixed-length tensor representation and generates context-oriented summaries of the real time audio data.

In an example embodiment, the hybrid summary generation module of the system includes a Natural Language Processing (NLP) Model wherein the NLP Model includes and extractive phase and an abstractive phase wherein the extractive phase identifies and selects sentences from a transcribed text output of the decoder and the abstractive phase receives as input selected sentences from the extractive phase and rephrases the selected sentences to generate summaries from the training audio data.

In an example embodiment, the training audio data input to the spectrogram generation module of the system is constrained to a fixed length context window no longer than 30 seconds and the real time audio data input to the spectrogram generation module is constrained to a fixed length context window no longer than 30 seconds.

In an example embodiment, the One Dimensional Convolution Neural Network (1D CNN) of the system includes filters which detect specific temporal features within a spectrogram generated by the spectrogram generation module to generate feature embeddings.

In an example embodiment, the 1D CNN of the system includes an activation function module which introduces non-linearity to the feature embeddings generated by the filters by utilizing Gaussian Error Linear Units.

In an example embodiment, the self-attention layer of the system includes a linear transformation module, an attention weight generation module and a contextual integration module to generate a new set of hidden states from the series of encoder hidden state tensors.

In an example embodiment, a method for generating context-oriented summary of audio conversations in real time, comprises pre-training a principal model with training audio data to generate summary, and the principal model includes a transformer-based model and a hybrid summary generation module, wherein the transformer-based model comprises a spectrogram generation module, a One Dimensional Convolutional Neural Network (1D CNN) layer, a sinusoidal positional embedding module, an encoder and a decoder; receiving by the pre-trained principal model, real-time audio data which is processed by the transformer-based model to generate a series of encoder hidden state tensors at the output of the encoder of the transformer-based model wherein the encoder includes convolutional neural networks (CNN) layers followed by self-attention layers; transforming by an independent self-attention layer, the series of encoder hidden state tensors into a new set of hidden states based on additional weighted attention scores of the independent self-attention layer; transforming by a mean pooling module, the new set of hidden states into a single fixed-length tensor representation; and selecting, by the decoder the relevant features from the single fixed-length tensor representation by utilizing the additional weighted attention scores of the independent self-attention layer and generate context-oriented summaries of the real-time audio data.

In an example embodiment, the method includes transforming the encoder hidden state tensors into a single fixed-length tensor representation by the mean pooling module and generating context-oriented summaries of the real time audio data by the decoder, by employing weighted attention scores of encoder's self-attention layers to select the most relevant features from the single fixed length tensor representation.

In an example embodiment, the method includes the hybrid summary generation module with a Natural Language Processing (NLP) Model, wherein the NLP Model includes and extractive phase and an abstractive phase where the extractive phase identifies and selects the most sentences from transcribed text output of the decoder and the abstractive phase receives as input selected sentences from the extractive phase and rephrases the selected sentences to generate summaries from the training audio data.

In an example embodiment, the method includes constraining the training audio data input to the spectrogram generation module to a fixed length context window no longer than 30 seconds and constraining the real time audio data input to the spectrogram generation module to a fixed length context window no longer than 30 seconds.

In an example embodiment the method includes detecting specific temporal features within the spectrogram generated by the spectrogram generation module to generate feature embeddings by the filters of the one dimensional Convolution Neural Network (1D CNN).

In an example embodiment the method includes introducing non-linearity to the feature embeddings generated by the filters by an activation function module of the 1D CNN which utilizes Gaussian Error Linear Units.

In an example embodiment the method includes the independent self-attention layer with a linear transformation module, an attention weight generation module and a contextual integration module to generate a new set of hidden states from the series of encoder hidden state tensors.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 depicts a simplified block diagram of a principal model in accordance with exemplary embodiments of the present invention;

FIG. 4 depicts a simplified block diagram of a system for generating context-oriented summary of audio conversations in real time in accordance with exemplary embodiments of the present invention; and

FIG. 5 depicts a simplified block diagram of a system based on self-attention mechanisms for generating context-oriented summary of audio conversations in real time in accordance with exemplary embodiments of the present invention.

### DETAILED DESCRIPTION

For the purpose of understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as a system, method, or computer program product. Example embodiments, thus, may take the form of a hardware embodiment, a software embodiment, or combination thereof.

### Introduction

In modern contact centers, where customer interactions are increasingly critical to business success, the ability to generate detailed, accurate, and contextually informed summaries of customer calls is paramount. These summaries are essential not only for facilitating efficient follow-up actions and ensuring consistent customer service but also for providing insights into customer sentiment, agent performance, and broader operational trends. Given the dynamic and multifaceted nature of customer calls, which can span a range of issues, emotional tones, and conversation flows, an automated system capable of accurately summarizing such interactions is essential.

However, current systems for generating these summaries exhibit significant shortcomings. Traditional approaches typically rely on human agents to manually review and summarize call transcripts, a process that is both labor-intensive and prone to errors. Further, manual summaries are often incomplete, inconsistent, and fail to fully capture the nuances of the conversation, including emotional undertones, sequential dependencies, and contextual shifts. Furthermore, these summaries may miss key elements necessary for effective future interactions, leading to fragmented service and diminishing the quality of customer engagement.

Another prevalent approach involves the use of transcription-based systems that convert audio recordings into text, followed by NLP algorithms to extract key information and generate summaries. While such systems offer automation, they remain reliant on the accuracy of speech recognition technology. This can be problematic, as speech recognition is frequently susceptible to errors, particularly in cases of background noise, overlapping speech, or unclear pronunciation. Moreover, traditional NLP models struggle with the inherent unstructured nature of human conversations, such as interruptions, informal speech, and non-linear exchanges, which often result in incoherent or incomplete summarization. These limitations undermine the effectiveness of transcription-based summarization systems, making them ill-suited for the complex, dynamic interactions typically encountered in contact centers.

Additionally, conventional audio signal processing techniques, while effective for isolated tasks such as speech recognition or sound classification, are not optimized to account for the sequential dependencies and contextual relationships that characterize human dialogue. As such, these techniques lack the ability to synthesize the broader context of the conversation, making it difficult to produce summaries that are coherent, accurate, and meaningful in the context of the overall call.

Techniques are disclosed herein for generating contextually aware summaries of audio conversations in real-time through an integrated approach that combines audio processing, natural language processing (NLP) and self-attention mechanisms. The system and method processes audio data/conversations to capture the complete temporal and sequential dependencies inherent in human conversations. The system and method further include self-attention mechanisms, which allow the system to focus attention on the most relevant portions of the conversation, irrespective of their position within the audio data and further utilizes Natural Language Processing (NLP) for summary generation.

This system and method thus facilitate the identification and prioritization of critical elements, such as key customer concerns, emotional shifts, and agent responses, ensuring that the generated summary reflects the most salient aspects of the interaction. In addition, the self-attention mechanism included in the system and method allows handling of long-range dependencies across the conversation, ensuring that essential information scattered throughout the dialogue is integrated into a coherent and contextually accurate summary. Further, by processing the raw audio data, the system bypasses the need for highly accurate transcription but retains the ability to extract meaningful insights and produce high-quality summaries.

Furthermore, the integration of advanced audio processing with self-attention significantly enhances the system's capacity to understand the underlying emotional tone and intent of the conversation. This allows for generation of summaries that not only reflect the factual content of the call but also capture the emotional nuances that are crucial for delivering personalized, empathetic customer service. By automating the generation of accurate, context-aware summaries, the system enables agents to quickly retrieve key information from past interactions, thereby reducing the cognitive load and time spent on manual review. This allows agents to focus more on customer interaction and problem resolution, rather than spending excessive time processing lengthy transcripts. Additionally, the summaries generated by the system provide supervisors and managers with actionable insights into customer sentiment, agent performance, and emerging trends, supporting data-driven decision-making and improving overall service quality.

### Computing Device

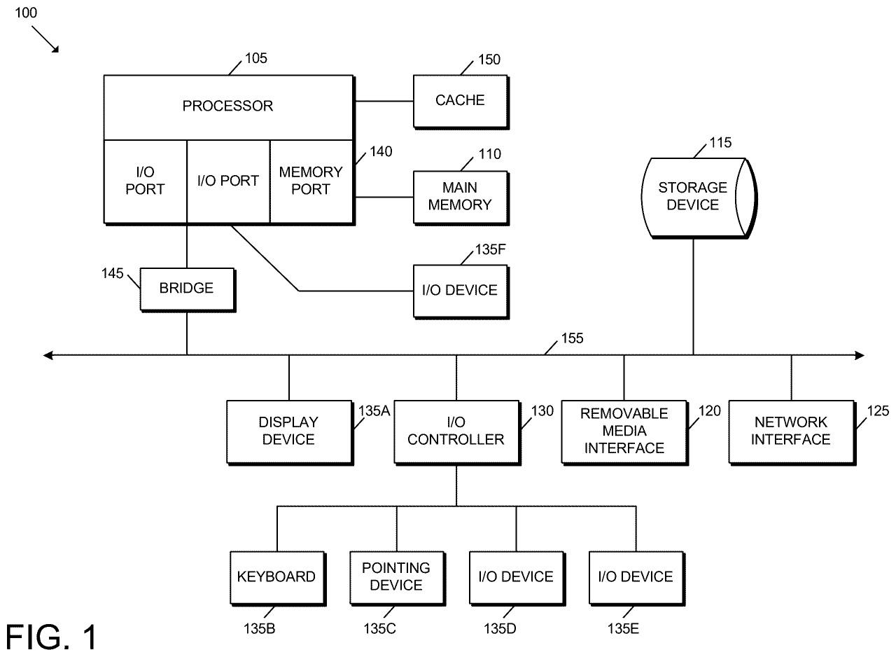

It will be appreciated that the systems and methods of the present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced. It should be understood that FIG. 1 is provided as a non-limiting example.

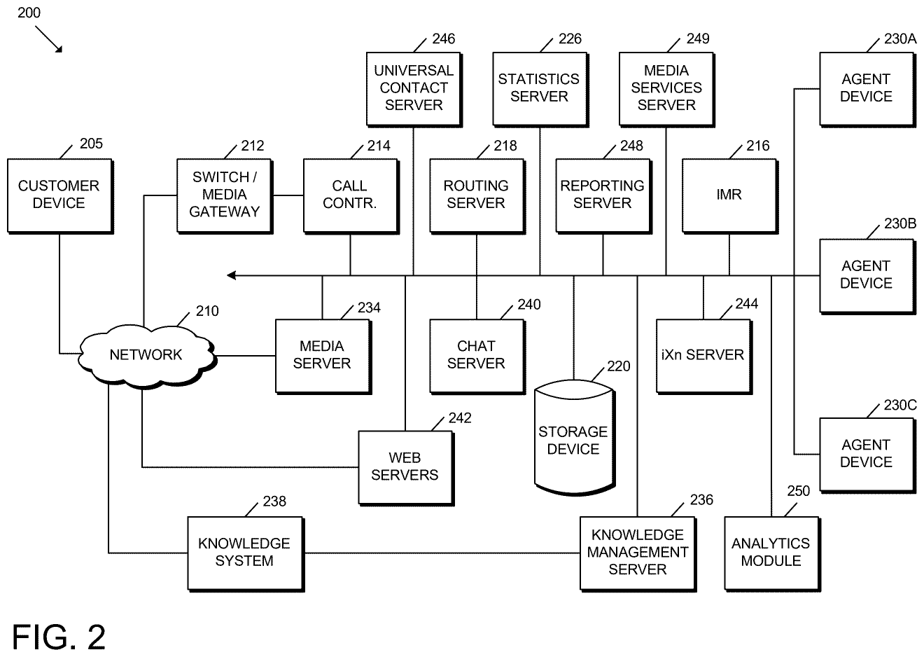

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures, such as for example, the contact center system 200 of FIG. 2 the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to, and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol. Further, the network may be a virtual network environment where various network components are virtualized.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “conversational bots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment, such as for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, or some combination thereof), service models (e.g., Software as a Service (“SaaS”), Platform as a Service (“PaaS”), Infrastructure as a Service (“IaaS”), and deployment models (e.g., private cloud, community cloud, public cloud, hybrid cloud, or some combination thereof). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; c; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, or some combination thereof) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VoIP calls), emails, voicemails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, or some combination thereof) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN, such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VoIP calls, or some combination thereof. The call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 enables automated processes, such as bot or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices represented generally by the storage device 220 for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, or some combination thereof. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VoIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, or some combination thereof. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources, such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, or some combination thereof. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, or some combination thereof.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as for example, a random-access memory (RAM), or stored in other non-transitory computer readable media, such as for example, a CD-ROM, flash drive, or some combination thereof. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, or some combination thereof. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Generating Context-Oriented Summary of Audio Conversations in Real Time

In modern contact centers, customer interactions are crucial to business success, making it important to generate accurate and detailed summaries of customer calls. These summaries help with efficient follow-up, consistent service, and providing insights into customer sentiment, agent performance, and operational trends. Given the complexity of customer calls covering a variety of issues, emotions, and conversation flows an automated system that can accurately summarize these interactions is essential. Techniques are disclosed herein for generating context oriented summary of audio conversations in real-time from a contact center by combining audio processing, natural language processing and self-attention mechanisms.

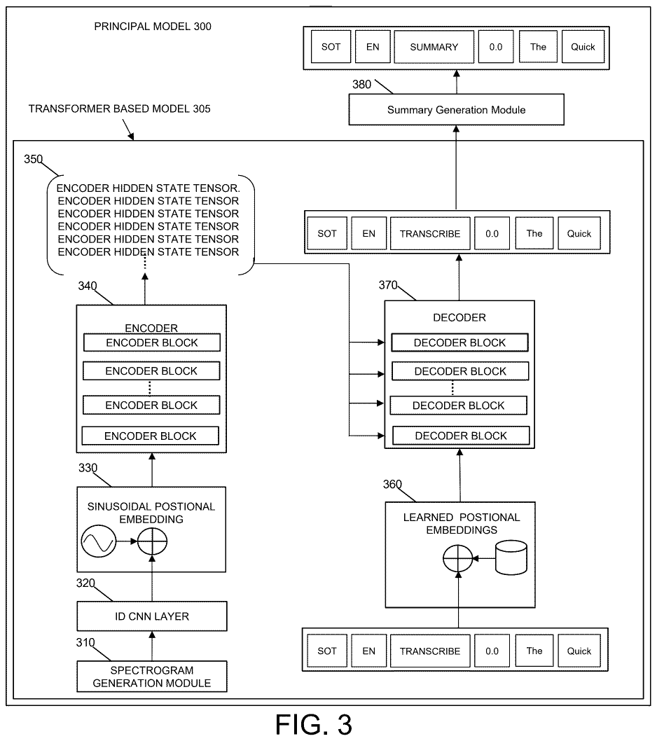

Techniques disclosed herein enables identification of key issues, customer concerns, and emotional shifts, ensuring the summary captures the most important details. Self-attention mechanisms allow the system to handle information spread throughout the conversation, creating a coherent and accurate summary. The system for generating context-oriented summary of audio conversations may be integrated with at least one of the modules or components of the contact center such as, the interactive media response (IMR) server 216 or the chat server 240 or media services server 249. Further, it should be understood that any of the computer-implemented components or modules described in relation to FIG. 3 or in any of the following figures may be implemented via types of computing devices, such as, for example, the computing device 100 of FIG. 1.

### Principal Model for Generating Context-Oriented Summary of Audio Conversations in Real Time

With reference now to FIG. 3, a principal model 300 is shown in accordance with exemplary embodiments of the present invention and can be implemented in software only, hardware only, or a combination of hardware and software. In the present disclosure a system and method for generating context-oriented summaries from conversations includes building a pre-trained summary generation model, which is referred to as the principal model 300. The principal model 300, includes a transformer-based model 305 for audio processing and a hybrid summary generation module 380 which includes a Natural Language Processing (NLP) model. The principal model 300 is pre-trained utilizing a large, diverse corpus of contact center conversation audio data/ training audio data to generate summary of the training audio data.

In an example embodiment, the principal model 300 is trained using training audio data, which is typically constrained by fixed-length context window (such as 30-second audio segments/spectrograms) thereby forming multiple segments. Thus, the information that is critical to the overall summary of the audio data may be spread across multiple segments.

This pre-training enables the principal model 300 to capture a wide variety of acoustic and linguistic features, including phonetic representations, speech prosody (pitch, rate, stress), speaker characteristics (such as accents or emotional tone), and contextual dependencies inherent in conversational speech. The principal model 300 leverages both the transformer-based model 305 such as a deep encoder-decoder architecture model and NLP model which is present in the hybrid summary generation module 380. The transformer-based model 305 utilized for audio processing includes a spectrogram generation module 310 to generate spectrograms, a 1D CNN layer 320 which converts the spectrograms to a sequence of feature embeddings, a sinusoidal positional embedding module 330 which introduces positional embedding to the sequence of feature embeddings generated by the 1D CNN, an encoder 340 which processes the sequence of feature embeddings which include positional embedding, to generate a series of high-dimensional feature embeddings or encoder hidden state tensors 350 and a decoder 370 to generate text transcriptions from the encoder hidden state tensors. The hybrid summary generation module 380 of the primary model 300 includes the NLP model which generates summary from the text transcriptions output by the decoder 370 module.

In an example embodiment, the transformer-based model 305 of the principal model 300 includes a spectrogram generation module 310 which receives training audio data from an audio repository/storage and converts them into spectrograms. The training audio data input to the spectrogram generation module is constrained to a fixed length context window by splitting the training audio data input into smaller, equally sized segments, each no longer than 30 seconds. Splitting the training audio into segments may enable the model to maintain its processing efficiency and accuracy while extending its capability to handle audio sequences of arbitrary length.

The segmented training audio data is then processed by a Discrete Fourier Transform (DFT) to convert the segmented training audio data which is a time-domain signal into its corresponding frequency domain representation. The DFT decomposes the segmented training audio data into its constituent frequencies, providing a frequency spectrum of the segmented training audio data. The frequency spectrum of the segmented training audio data is then processed by utilizing filter-banks which are designed to emphasize low-frequency components.

Such filter banks which are designed to emphasize low-frequency components are crucial in many audio applications such as speech or environmental sound processing. The frequency spectra obtained from each of the segmented training audio data are then stacked together across the time axis to form a spectrogram. The spectrogram provides a two-dimensional time-frequency representation of the segmented training audio data, where the x-axis represents time, the y-axis represents frequency bins, and the intensity at each point corresponds to the magnitude of the signal at that time and frequency.

The spectrograms generated by the spectrogram generation module 310 are then input to a one-dimensional convolutional neural network (1D CNN) 320 of the transformer-based model 305 of the principal model 300, which is designed to extract features from the spectrogram thereby generating a sequence of feature embeddings. The 1D CNN 320 consists of several modules such as, filters, strides, padding and activation functions.

In an example embodiment, the filters of the 1D CNN 320, comprises parameters which are to be convolved with the spectrograms generated by the spectrogram generation module 310. Each filter of the 1D CNN layer detects specific temporal features within the spectrogram generated by the spectrogram generation module, such as frequency peaks or periodic patterns to generate a sequence of feature embeddings. The 1D CNN 320, further includes the strides module which controls on how much the filter shifts with each operation. A stride of one moves the filter one unit at a time, whereas larger strides result in faster processing and smaller output dimensions. The padding module of the 1D CNN 320 maintains the dimensions of the spectrogram and avoids loss of edge information. Zero-padding is typically applied to the spectrogram to ensure that the convolution can be performed at the edges of the spectrogram. Further, the activation function module of the 1D CNN 320 introduces non-linearity to the sequence of feature embeddings generated by the filters by utilizing Gaussian Error Linear Units (GELU) which enables the model to learn complex relationships between the sequence of feature embeddings.

The sequence of feature embeddings from the 1D-CNN layer 320 are then input to a sinusoidal positional embedding module 330 of the transformer-based model 305 of the principal model 300. The sinusoidal positional embedding module 330 introduces positional embedding to the sequence of feature embeddings generated by the 1D CNN 320, and thus provides information about the relative position of the feature embeddings of the audio data, thereby enabling the model to retain the temporal order of the audio data. This is essential for maintaining the flow of the conversation and for generating summaries that are temporally consistent with the original audio thereby enhancing the model's ability to generate accurate summaries that align with the original audio's temporal and prosodic properties.

The sequence of feature embeddings which include positional embedding are then transmitted to the encoder 340 of the transformer-based model 305. The encoder 340 processes the sequence of feature embeddings which include positional embedding and generates a series of encoder hidden states tensors 350, which represent a high-dimensional feature map of the training audio data. The series of encoder hidden state tensors 350 encapsulate the acoustic and linguistic information necessary for understanding the content of the conversation. The series of encoder hidden state tensors 350 also capture the temporal dependencies within the sequence of feature embeddings which include positional embedding, which is essential for understanding speech patterns, prosody, and conversational turns. The series of encoder hidden state tensors 350 stores essential contextual features of the sequence of feature embeddings which include positional embedding and are stored for further processing.

These series of encoder hidden state tensors generated by the encoder can range from individual phonetic symbols to larger linguistic structures such as words or phrases, depending on the level of abstraction achieved by the model. The encoder consists of several layers of convolutional neural networks (CNNs) followed by self-attention layers which generates weighted attention scores. The encoder's self-attention layers enable the model to attend to different parts of the training audio data simultaneously, capturing long-range dependencies that are crucial for understanding the full context of audio data.

The series of encoder hidden state tensors 350 are then passed to the decoder 370 of the transformer-based model 305 of the principal model, which utilizes learned positional embeddings 360. The learned positional embeddings 360 helps the decoder identify the position of each of the feature embeddings in the encoder hidden state tensors. The decoder 370 is based on an auto-regressive mechanism and generates a text transcription of the training audio data. The auto-regressive nature of the decoder means that it generates the transcription token by token, with each new token being conditioned on the previous token(s) in the sequence. This ensures that the transcription generated remains coherent and maintains the correct flow of information. The decoder uses cross-attention mechanisms to focus on the most relevant parts of the encoder's output for each token generation step. Cross-attention allows the decoder to “attend” to different parts of the encoder hidden state tensors 350, determining which encoder hidden state tensors 350 are most pertinent to the current step in generating the text transcription.

The decoder's 370 use of cross-attention enables it to handle long-range dependencies in the audio data. As the audio data is processed in 30 second segments, information that is critical to the overall summary may be spread across multiple segments. The cross-attention mechanism enables the decoder to dynamically focus on the relevant information from all parts of the conversation, ensuring that the summary reflects the essential details, even if they are scattered across different segments.

Each token generated by the decoder 380 is based on the context provided by the previous tokens, which ensures that the generated summary retains coherence and logical flow. The decoder generates a new token at each step, using the weighted attention scores of the encoder's 340 self-attention layers to select the most relevant features from the encoder's output. This step is repeated iteratively until the decoder generates an end token, signaling the completion of the transcription. The use of an auto-regressive mechanism coupled with cross-attention allows the model to produce fluent, concise transcribed outputs, which are then passed on to the hybrid summary generation module 380 which includes the NLP-based model to generate text summaries that capture the most important elements of the customer interaction.

The transcribed text output from the encoder decoder model is input to the NLP based hybrid summary generator model 308 which includes an extractive phase and an abstractive phase. The extractive phase identifies and selects the most important sentences from the transcribed text output of the decoder 370. In an example embodiment the extractive phase is based on algorithms such as, BERT to rank sentences based on their relevance and identify and select the most relevant sentences. The selected sentences from the extractive phase are then input to the abstractive summarization model wherein the abstractive summarization model rephrases and generates summaries of the training audio data in a coherent and concise manner.

### System for Generating Context-Oriented Summary of Audio Conversations in Real Time

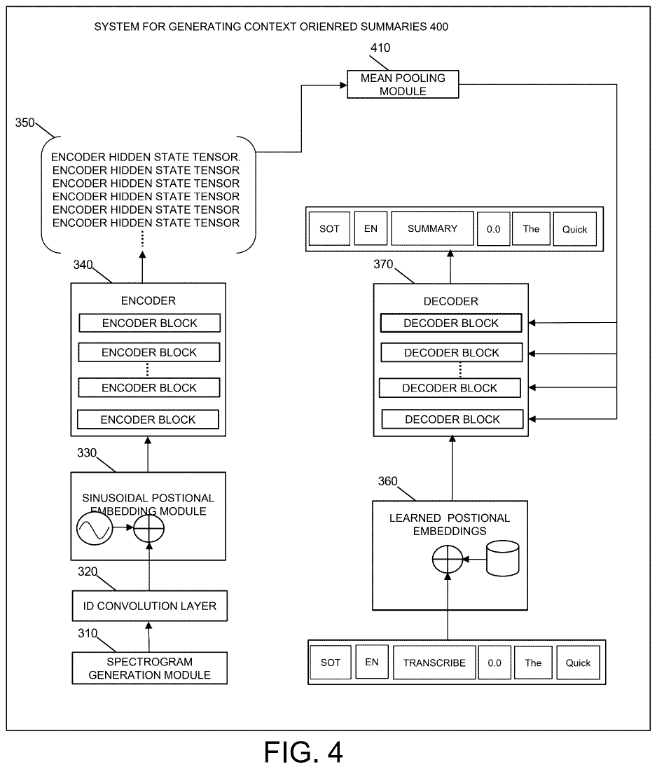

With reference now to FIG. 4, a system and method for generating context-oriented summary of audio conversations in real time 400 is shown in accordance with exemplary embodiments of the present invention and can be implemented in software only, hardware only, or a combination of hardware and software.

In the present disclosure a system and method for generating context-oriented summary of audio conversations/audio data includes presenting real time audio data which forms part of an agent user conversation to the pretrained principal model 300. The real time audio data is processed by the spectrogram generation module 310, the 1D convolution layer 320, the sinusoidal position embedding module 330, and the encoder 340 to generate the encoder hidden state tensors 350 for the real time audio data.

Since the principal model is trained by training audio data which is constrained by fixed-length context windows (such as 30-second audio segments) the system for context-oriented audio summary from conversations leverages this pre-trained model and limits/constraints the real-time audio data input to the spectrogram generation module by fixed-length context windows (such as 30-second audio segments) by splitting the real-time audio input to the spectrogram generation module data into smaller, equally sized segments, each no longer than 30 seconds. This segmentation ensures that the model can maintain its processing efficiency and accuracy while extending its capability to handle audio sequences of arbitrary length. The segmentation of the real time audio data is critical because it allows the model to process the real time audio data audio in manageable, consistent segments that match the training conditions of the principal model.

The encoder hidden state tensors 350, which are generated from the real time audio data are processed by a mean pooling module 410 which computes the element-wise average of the encoder hidden state tensors. The mean pooling operation condenses the information from all segments of the training audio data into a single, fixed-length tensor representation. This fixed-length tensor representation serves as an aggregated representation of the entire audio sequence, preserving the salient information from each segment of the real time audio input while capturing the entirety of the conversation and provides a global context ensuring that the resulting summary is both accurate and contextually appropriate.

The fixed length tensor representation after mean pooling 350 is processed by the decoder 370 to generate a new token at each step, using the weighted attention scores of the encoder's self-attention layers 340 to select the most relevant features from the fixed length tensor representation. This step is repeated iteratively until the decoder generates an end token, signaling the completion of the summary. The use of an auto-regressive mechanism coupled with cross-attention by the decoder 370 allows the model to produce context-oriented summaries of the real-time audio data in a coherent and concise manner that captures the most important elements of the customer interaction.

### System Based on Self-Attention Mechanisms for Generating Context-Oriented Summary of Audio Conversations in Real Time

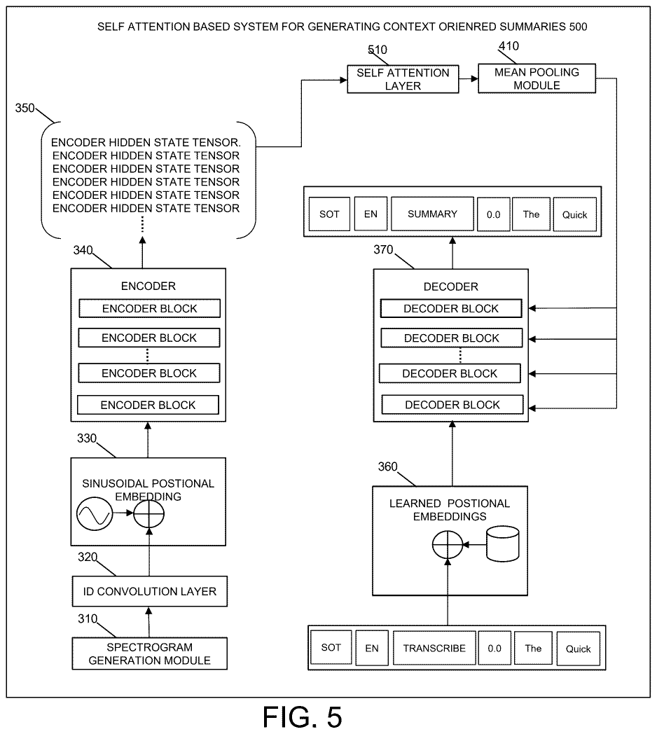

With reference now to FIG. 5, a system based on self-attention mechanisms for generating context-oriented summary of audio conversations in real time 500 is shown in accordance with exemplary embodiments of the present invention and can be implemented in software only, hardware only, or a combination of hardware and software.

In the present disclosure a system and method based on self-attention mechanisms for generating context-oriented summary of audio conversations/audio data includes presenting real time audio data which forms part of an agent user conversation to the pretrained principal model 300. The real time audio data is processed by the spectrogram generation module 310, the 1D convolution layer 320, the sinusoidal position embedding module 330, and the encoder 340 to generate the encoder hidden state tensors 350 for the real time audio data.

Since the principal model is trained by training audio data which is constrained by fixed-length context windows (such as 30-second audio segments) the system for context-oriented audio summary from conversations leverages this pre-trained model and limits/constraints the real-time audio data input to the spectrogram generation module by fixed-length context windows (such as 30-second audio segments) by splitting the real-time audio input to the spectrogram generation module data into smaller, equally sized segments, each no longer than 30 seconds. This segmentation ensures that the model can maintain its processing efficiency and accuracy while extending its capability to handle audio sequences of arbitrary length. The segmentation of the real time audio data is critical because it allows the model to process the real time audio data audio in manageable, consistent segments that match the training conditions of the principal model.

In the present disclosure a system and method based on self-attention mechanisms for generating context-oriented summary of audio conversations/audio data includes presenting the encoder hidden state tensors 350 from the encoder 340 to an independent self-attention layer 510 to generate a new set of hidden states after which the output from the independent self-attention layer is processed by the mean pooling module 410. The output from the mean pooling module 410 is then transmitted to the decoder 370. Processing by the independent self-attention layer 510 before mean pooling preserves better contextual information to extract more meaning and relationships in the real time audio data segments. The new set of hidden states which is processed by the mean pooling layer synthesizes a single composite representation for the entire audio sequence that serves as a composite tensor representation for the auto-regressive decoding. The independent self-attention mechanism employed in this approach significantly enhances the model's ability to extract deeper connections & relations within the sequences, leading to more accurate contextually relevant summaries.

In an example embodiment, the independent self-attention layer 510 transforms the encoder hidden state tensor tensors 350 to incorporate information from other positions in the sequence to generate a new set of hidden states that have been contextually enriched. The independent self-attention layer includes a linear transformation module, an attention weight generation module and a contextual integration module. The linear transformation module transforms the encoder hidden state tensors into Query (Q), Key (K), and Value (V) vectors using learned weight matrices. This allows the model to project the encoder hidden tensors into different subspaces that capture various aspects of the input. The Q and K vectors from the linear transformation module are then passed on to the attention weight generation module to compute attention scores, which determine how much focus each encoder hidden tensor should have on every other encoder hidden tensor in the sequence. These scores are scaled and normalized using a SoftMax function to produce attention weights. The attention weights are then passed on to the contextual integration module of the independent self-attention module which weighs the value vectors, and additional weighted attention scores are computed which integrates information from other positions in the sequence, allowing each encoder hidden tensor to be updated based on its relevance to other encoder hidden tensors and a new set of hidden states that have been contextually enriched are generated.

The new set of hidden states, which are generated by the independent self-attention layer 510 are processed by a mean pooling module 410 which computes the element-wise average of the new set of hidden states. The mean pooling operation condenses the new set of hidden states into a single, fixed-length tensor representation. This fixed-length tensor representation serves as an aggregated representation of the entire audio sequence, preserving the salient information from each segment of the real time audio input while capturing the entirety of the conversation and provides a global context ensuring that the resulting summary is both accurate and contextually appropriate.

The fixed length tensor representation after mean pooling 350 is processed by the decoder 370 to generate a new token at each step, using the additional weighted attention scores of the independent self-attention layer 510 to select the most relevant features from the fixed length tensor representation. This step is repeated iteratively until the decoder generates an end token, signaling the completion of the summary. The use of an auto-regressive mechanism coupled with cross-attention allows the model to produce context-oriented summaries of the real-time audio data in a coherent and concise manner that captures the most important elements of the customer interaction.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A system for generating context-oriented summary of audio conversations in real time, the system comprising:
a principal model which is pre-trained with training audio data to generate summary, and the principal model includes a transformer-based model and a hybrid summary generation module, wherein the transformer-based model comprises a spectrogram generation module, a One Dimensional Convolutional Neural Network (1D CNN) layer, a sinusoidal positional embedding module, an encoder and a decoder;
the principal model after pretraining receives real-time audio data which is processed by the transformer-based model to generate a series of encoder hidden state tensors, output by the encoder of the transformer-based model, wherein the encoder includes convolutional neural networks (CNN) layers followed by self-attention layers;
an independent self-attention layer to transform the series of encoder hidden state tensors into a new set of hidden states based on additional weighted attention scores of the independent self-attention layer;
a mean pooling module, to transform the new set of hidden states into a single fixed-length tensor representation; and
the decoder, to utilize the additional weighted attention scores of the independent self-attention layer to select relevant features from the single fixed-length tensor representation and generate context-oriented summaries of the real time audio data.

2. The system of claim 1, wherein the mean pooling module transforms the encoder hidden state tensors into a single fixed-length tensor representation and the decoder utilizes weighted attention scores of encoder's self-attention layers to select the relevant features from the single fixed-length tensor representation and generates context-oriented summaries of the real time audio data.

3. The system of claim 1, wherein the hybrid summary generation module includes a Natural Language Processing (NLP) Model.

4. The system of claim 3, wherein the NLP Model includes and extractive phase and an abstractive phase wherein the extractive phase identifies and selects sentences from a transcribed text output of the decoder.

5. The system of claim 4, wherein the abstractive phase receives as input selected sentences from the extractive phase and rephrases the selected sentences to generate summaries from training audio data.

6. The system of claim 1, wherein the training audio data, input to the spectrogram generation module is constrained to a fixed length context window no longer than 30 seconds.

7. The system of claim 1, wherein real time audio data input to the spectrogram generation module is constrained to a fixed length context window no longer than 30 seconds.

8. The system of claim 1, wherein the One Dimensional Convolutional Neural Network (1D CNN) layer includes filters which detect specific temporal features within a spectrogram generated by the spectrogram generation module to generate feature embeddings.

9. The system of claim 1, wherein the 1D CNN layer includes an activation function module which introduces non-linearity to generated feature embeddings by utilizing Gaussian Error Linear Units.

10. The system of claim 1, wherein the independent self-attention layer includes a linear transformation module, an attention weight generation module and a contextual integration module to generate a new set of hidden states from the series of encoder hidden state tensors.

11. A method for generating context-oriented summary of audio conversations in real time, the method comprising:
pre-training a principal model with training audio data to generate summary, and the principal model includes a transformer-based model and a hybrid summary generation module, wherein the transformer-based model comprises a spectrogram generation module, a One Dimensional Convolutional Neural Network (1D CNN) layer, a sinusoidal positional embedding module, an encoder and a decoder;
receiving by the pre-trained principal model, real-time audio data which is processed by the transformer-based model to generate a series of encoder hidden state tensors, output by the encoder of the transformer-based model, wherein the encoder includes convolutional neural networks (CNN) layers followed by self-attention layers;
transforming by an independent self-attention layer, the series of encoder hidden state tensors into a new set of hidden states based on additional weighted attention scores of the independent self-attention layer;
transforming by a mean pooling module, the new set of hidden states into a single fixed-length tensor representation; and
selecting by the decoder, relevant features from the single fixed-length tensor representation by utilizing the additional weighted attention scores of the independent self-attention layer and generate context-oriented summaries of the real-time audio data.

12. The method of claim 11, wherein the encoder hidden state tensors are transformed into a single fixed-length tensor representation by the mean pooling module and the decoder, utilizes weighted attention scores of encoder's self-attention layers to select relevant features from the single fixed-length tensor representation and generates context-oriented summaries of the real-time audio data.

13. The method of claim 11, wherein the hybrid summary generation module includes a Natural Language Processing (NLP) Model.

14. The method of claim 13, wherein the NLP Model includes and extractive phase and an abstractive phase wherein the extractive phase identifies and selects sentences from transcribed text output of the decoder.

15. The method of claim 14, wherein the abstractive phase receives as input selected sentences from the extractive phase and rephrases the selected sentences to generate summaries from the training audio data.

16. The method of claim 11, wherein the training audio data, input to the spectrogram generation module is constrained to a fixed length context window no longer than 30 seconds.

17. The method of claim 11 wherein the real-time audio data, input to the spectrogram generation module is constrained to a fixed length context window no longer than 30 seconds.

18. The method of claim 11, wherein the One Dimensional Convolutional Neural Network (1D CNN) layer includes filters which detect specific temporal features within a spectrogram generated by the spectrogram generation module to generate feature embeddings.

19. The method of claim 11, wherein the 1D CNN layer includes an activation function module which introduces non-linearity to the generated feature embeddings by utilizing Gaussian Error Linear Units.

20. The method of claim 11, wherein the independent self-attention layer includes a linear transformation module, an attention weight generation module and a contextual integration module to generate a new set of hidden states from the series of encoder hidden state tensors.
